(19) United States
(12) Patent Application Publication
(10) Pub. No.: US 2017/0220401 A1
(43) Pub. Date: Aug. 3, 2017

(54) METHOD, DEVICE, AND COMPUTER-READABLE STORAGE MEDIUM FOR CALLING A PROCESS

(71) Applicant: Beijing Xiaomi Mobile Software Co., Ltd., Beijing (CN)

(72) Inventors: QIAO REN, Beijing (CN); Ming ZHAO, Beijing (CN); Enxing HOU, Beijing (CN)

(21) Appl. No.: 15/412,247

(22) Filed: Jan. 23, 2017

(30) Foreign Application Priority Data
Jan. 29, 2016 (CN) 201610066816.3

(51) Int. Cl. G06F 9/54

(52) U.S. Cl. CPC G06F 9/547; G06F 9/542; H04M 1/72522

(57) ABSTRACT

The present disclosure relates to a method and device for calling a process. The method includes: setting a call frequency for a process to be called by a designated application, based on a usage state of the designated application; and calling the process at the set call frequency.

### CROSS-REFERENCE TO RELATED APPLICATION

This application is based on and claims priority to Chinese Patent Application No. 201610066816.3, filed Jan. 29, 2016, the entire contents of which are incorporated herein by reference.

### TECHNICAL FIELD

The present disclosure relates to terminal technology and, more particularly, to a method, a device, and computer-readable storage medium for calling a process.

### BACKGROUND

Applications with various kinds of functions have being developed for use in terminals to meet users' needs. Typically, after a user initiates an application in a terminal, the application calls one or more processes at certain predetermined call frequencies, to complete certain functions of the application.

### SUMMARY

According to a first aspect of the present disclosure, there is provided a method for calling a process, comprising: setting a call frequency for a process to be called by a designated application, based on a usage state of the designated application; and calling the process at the set call frequency.

According to a second aspect of the present disclosure, there is provided a device for calling a process, comprising: a processor; and a memory for storing instructions executable by the processor; wherein the processor is configured to: set a call frequency for a process to be called by a designated application, based on a usage state of the designated application; and call the process at the set call frequency.

According to a third aspect of the present disclosure, there is provided a non-transitory computer-readable storage medium storing instructions that, when executed by a processor of a terminal, cause the terminal to perform a method for calling a process, the method comprising: setting a call frequency for a process to be called by a designated application, based on a usage state of the designated application; and calling the process at the set call frequency.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for calling a process, according to an exemplary embodiment.

FIG. 2 is a flowchart of a method for calling a process, according to an exemplary embodiment.

FIG. 3 is a flowchart of a method for calling a process, according to an exemplary embodiment.

FIG. 4 is a block diagram of a device for calling a process, according to an exemplary embodiment.

FIG. 5 is a block diagram of a setting module of the device shown in FIG. 4, according to an exemplary embodiment.

FIG. 6 is a block diagram of a device for calling a process, according to an exemplary embodiment.

### DETAILED DESCRIPTION

Exemplary embodiments will now be illustrated in detail, examples of which are illustrated in the accompanying drawings. The following description refers to the accompanying drawings in which the same numbers in different drawings represent the same or similar elements, unless otherwise described. The implementations described in the following exemplary embodiments do not represent all of the implementations consistent with the present disclosure. Instead, they are only examples of methods and devices consistent with aspects of the present disclosure as recited in the appended claims.

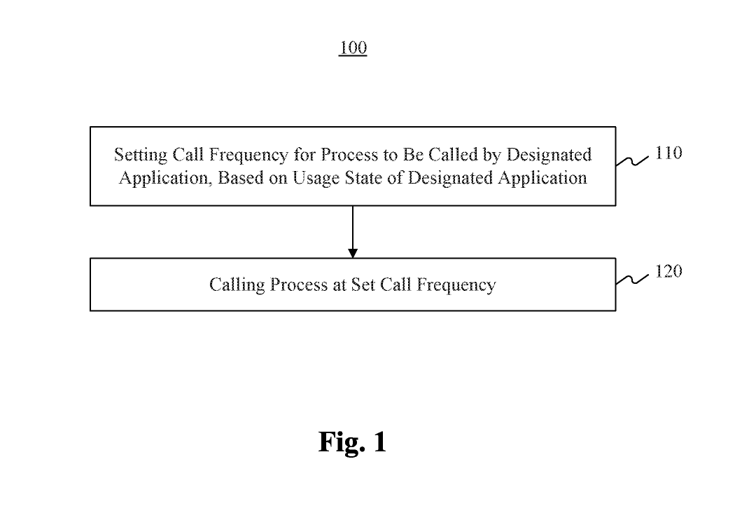

FIG. 1 is a flowchart of a method 100 for calling a process, according to an exemplary embodiment. Consistent with the disclosed embodiments, the method 100 is performed by a terminal. For example, the terminal may be a mobile phone. Referring to FIG. 1, the method 100 includes the following steps 110 and 120.

In step 110, the terminal sets a call frequency for a process to be called by a designated application, based on a usage state of the designated application. The application is installed on and can be run by the terminal.

In step 120, the terminal calls the process at the set call frequency.

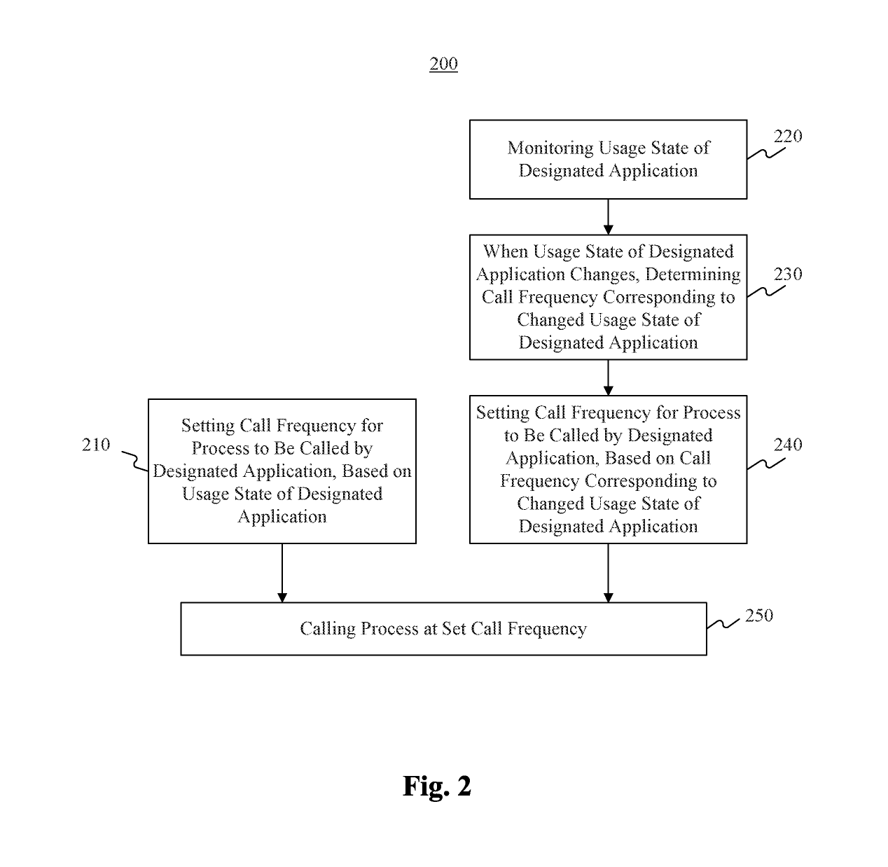

FIG. 2 is a flowchart of a method 200 for calling a process, according to an exemplary embodiment. Consistent with the disclosed embodiments, the method 200 is performed by a terminal. For example, the terminal may be a mobile phone. Referring to FIG. 2, the method 200 includes the following steps 210-250.

In step 210, the terminal sets a call frequency for a process to be called by a designated application, based on a usage state of the designated application.

In exemplary embodiments, the terminal is preset with a list of designated applications. The list stores identifiers of one or more designated applications. When the terminal detects that a designated application in the list is installed on the terminal, the terminal executes the disclosed methods for calling a process used by the designated application.

In some embodiments, the terminal also allows a user to manually add a designated application to the list of designated applications, such that the user can control the execution of the disclosed methods, based on the user's particular needs.

The usage state of the designated application is a predetermined state recognized by the terminal. For example, the usage state includes but is not limited to a foreground state, a background state, and a closed state.

Specifically, the foreground state is a state in which the designated application is initiated and currently in use. The background state is a state in which the designated application is initiated but currently not in use, while another application is currently in use. Moreover, the closed state is a state in which the designated application is not initiated or a state after the designated application is closed by a termination command issued by the operating system of the terminal or the user of the terminal.

Consistent with the disclosed embodiments, a call frequency corresponding to each usage state is preset in the terminal, such that the designated application: calls a process at the fastest rate when the designated application is in the foreground state; calls the process at a lower rate when the designated application is in the background state; and calls the process at the lowest rate when the designated application is in the closed state.

In various embodiments, the terminal may set the call frequencies used for each designated application separately, such that the same usage state can have different frequencies for different designated applications usage state. Alternatively, the terminal may set the call frequencies used for different designated applications uniformly, such that all the designated applications use the same call frequency for the same usage state. Moreover, in some embodiments, the terminal also allows the user to manually set the call frequency used by each designated application in each usage state.

Because the designated application may have multiple usage states that correspond to different call frequencies, the terminal needs to monitor the usage state of the designated application, and reset the call frequency when the usage state of the designated application changes, according to the following steps 220-240.

In step 220, the terminal monitors the usage state of the designated application.

In step 230, when the usage state of the designated application changes, the terminal determines the call frequency corresponding to the changed usage state of the designated application.

In the disclosed embodiments, the change of the usage state of the designated application includes but is not limited to the following cases.

In a first case, the designated application is initially in the closed state. After the designated application is initiated, the designated application changes from the closed state to the foreground state.

In a second case, the designated application has been initiated. When the user operates the “HOME” button of the terminal such that the designated application enters a background mode, the designated application changes to the background state.

In a third case, the designated application has been initiated. When the user operates a close button of the terminal to terminate the designated application, the designated application changes to the closed state.

In a fourth case, the designated application has been initiated and is initially in the background state. When the user operates the terminal to forcibly clear the memory space of the terminal, the terminal terminates the designated application. As such, the designated application changes from the background state to the closed state.

In a fifth case, the designated application has been initiated and is initially in the background state. When the user works on or directly interacts with the designated application, the designated application switches to the foreground state.

In step 240, the terminal sets the call frequency for the process to be called by the designated application, based on the call frequency corresponding to the changed usage state of the designated application.

After step 210 or step 240 is performed, the terminal proceeds to step 250. In step 250, the terminal calls the process at the set call frequency.

As described above, the list of the designated applications may contain more than one designated application, and a designated application may need to call more than one process. In some embodiments, for each of the designated applications in the list, the terminal can pre-select the process(es) to be called according to the disclosed methods for calling a process, as needed. The present disclosure does not require the terminal to apply the disclosed methods to all the processes called by each designated application.

In some embodiments, the terminal also allows the user to manually select one or more processes in a certain designated application as a process to be called using the disclosed methods.

In some embodiments, the relationships between the usage states of a specific application are set according to the following: the call frequency corresponding to the foreground state is higher than the call frequency corresponding to the background state; and the call frequency corresponding to the background state is higher than the call frequency corresponding to the closed state.

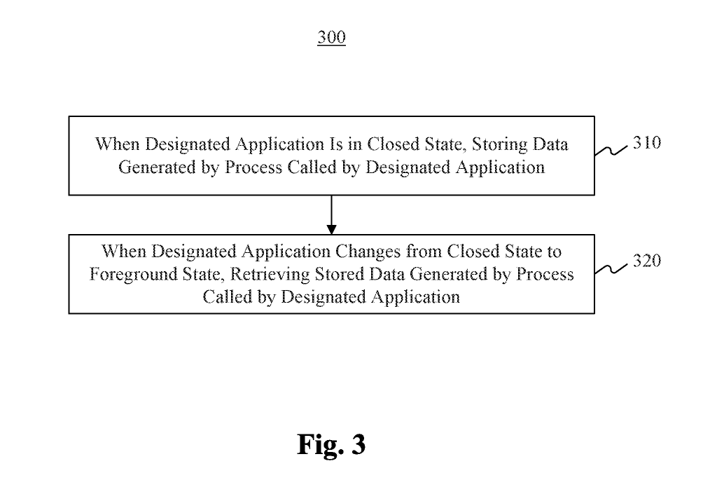

By setting different call frequencies for different usage states, the method 200 achieves the following effects. Specifically, when a designated application is in the foreground state, the call frequency is set at a high value such that the designated application can call a process fast and timely, to achieve the corresponding function(s). When the designated application is in the background state, the designated application calls the process at a reduced call frequency to reduce consumption of the system resources (e.g., central processing unit (CPU) time, cache, etc.). Moreover, when the designated application is in the closed state, the designated application still calls the process but at a further reduced call frequency, such that certain function(s) of the designated application can be maintained. In addition, as described in detail below in connection with a method 300 (FIG. 3), data generated by the called process in the closed state is saved, such that when the designated application is restarted, the designated application can quickly and timely retrieve and use the data generated by the process in the closed state.

For example, the terminal is installed with an intelligent control application for controlling various devices connected to the terminal. The intelligent control application performs a scan function by calling a scan interface at a certain call frequency, to acquire a list of online devices in a Local Area Network (LAN). When the intelligent control application is in the foreground state, the intelligent control application scans the online devices frequently so as to quickly update the list of the online devices in the real time. For example, the call frequency for calling the scan function in the foreground state is set to be 1 time every second. Moreover, in the background state, the intelligent control application only needs to scan the online devices less frequently. For example, the call frequency used in the background state is set to be 1 time every 5 seconds. Further, when the intelligent control application is in the closed state, the intelligent control application can scan the online devices at an even lower frequency. For example, the call frequency used in the closed state is set to be 1 time every 60 seconds or longer.

According to the method 200, the terminal dynamically adjusts the call frequency of a process based on the change of the usage state of the designated application. This way, when the designated application is used by the user (i.e., in the foreground state), the designated application can timely and quickly call a process. Whereas when the designated application is not used by the user (i.e., in the background or closed state), the designated application calls the process less frequently, so as to reduce consumption of the system resources. Moreover, the non-zero call frequency used in the closed state enables the acquisition of the data required by the designated application even after the designated application is closed.

FIG. 3 is a flowchart of a method 300 for calling a process, according to an exemplary embodiment. Consistent with the disclosed embodiments, the method 300 is performed in conjunction with the method 200. Referring to FIG. 3, the method 300 includes the following steps 310 and 320.

In step 310, when a designated application is in a closed state, the terminal stores data generated by a process called by the designated application.

In the disclosed embodiments, even when the designated application is in the closed state, the designated application still calls the process occasionally. When called, the process generates corresponding data. However, since the designated application is not initiated, the designated application would not use the data generated by the process. Instead, the terminal stores the generated data in a predetermined storage location in a storage device, such that the designated application can acquire the generated data from the predetermined storage location directly after the designated application is initiated.

As described above in connection with the method 200, when the designated application is in the closed state, the terminal may call the process at a call frequency corresponding to the closed state. As such, in some embodiments, each time the process is called, the terminal acquires the data newly generated by the process and updates the data generated from the last call with the newly generated data. For example, the terminal deletes the data generated from the last call and stores the data generated from the current call in the predetermined storage location.

In step 320, when the designated application changes from the closed state to a foreground state, the terminal retrieves the stored data generated by the process called by the designated application.

After the designated application is initiated, the designated application changes from the closed state to the foreground state. The terminal then retrieves, from the predetermined storage location, the data generated by the called process when the designated application is in the closed state, such that the data can be used by the designated application after the initiation. Moreover, the terminal resets the call frequency for the process according to step 240 (i.e., changing to the call frequency corresponding to the foreground state).

According to the method 300, the process continues to be called by the designated application after the designated applications enters the closed state, and the data generated by the process in the closed state is continuously saved and updated by the terminal. The saved data can be retrieved and used by the designated application once the designated application is restarted and enters the foreground state. As such, the method 300 improves the efficiency and the accuracy for the designated application to acquire the data generated by a process.

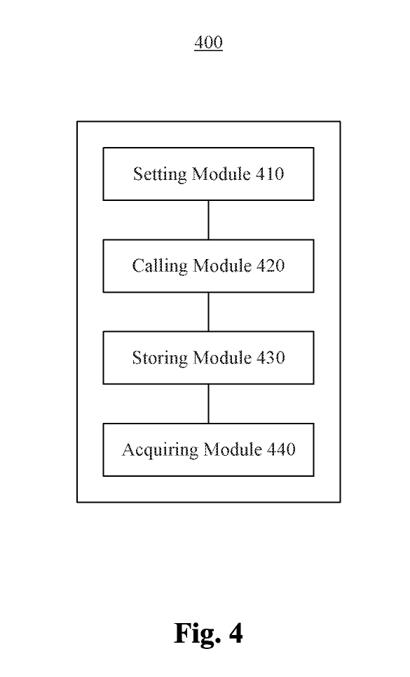

FIG. 4 is a block diagram of a device 400 for calling a process, according to an exemplary embodiment. Consistent with the disclosed embodiments, the device 400 may be implemented as a part or the whole of a terminal. Referring to FIG. 4, the device 400 includes a setting module 410 and a calling module 420.

The setting module 410 is configured to set a call frequency for a process to be called by a designated application, based on a usage state of the designated application. The designated application is installed on the terminal.

The calling module 420 is configured to call the process at the set call frequency

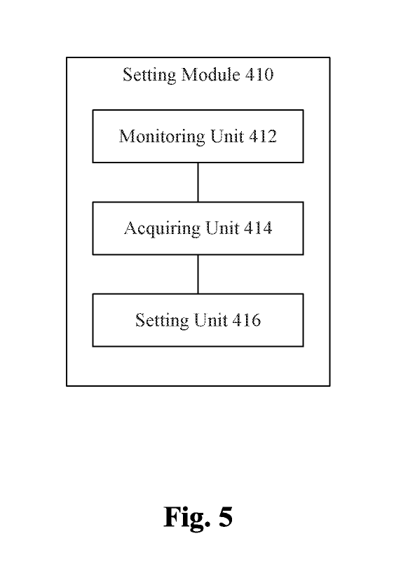

FIG. 5 is a block diagram of the setting module 410 shown in FIG. 4, according to another exemplary embodiment. As shown in FIG. 5, the setting module 410 further includes a monitoring unit 412, an acquiring unit 414, and a setting unit 416.

The monitoring unit 412 is configured to monitor the usage state of the designated application.

The acquiring unit 414 is configured to determine, when the usage state of the designated application changes, a call frequency corresponding to the changed usage state of the designated application.

The setting unit 416 is configured to set the call frequency for the process to be called by the designated application, based on the call frequency corresponding to the changed usage state of the designated application.

In the disclosed embodiments, the usage state includes but is not limited to a foreground state, a background state, and a closed state. The call frequency corresponding to the foreground state is set to be higher than the call frequency corresponding to the background state, and the call frequency corresponding to the background state is set to be higher than the call frequency corresponding to the closed state.

Referring back to FIG. 4, in some embodiments, the device 400 further includes a storing module 430 and an acquiring module 440.

The storing module 430 is configured to store data generated by the process called by the designated application, when the designated application is in the closed state.

The acquiring module 440 is configured to retrieve the stored data generated by the process, when the designated application changes from the closed state to the foreground state.

According to the above-described methods and devices, the terminal dynamically adjusts the call frequency of a process based on the change of the usage state of the designated application. This way, when the designated application is in use (i.e., in the foreground state), the designated application can timely and quickly call a process. Whereas when the designated application is not in use (i.e., in the background or closed state), the designated application calls the process less frequently, so as to reduce consumption of the system resources.

Moreover, the non-zero call frequency used in the closed state ensures the process can still be called even after the designated application is closed, such that the data required by the designated application is continuously acquired and stored in the closed state. The stored data can be retrieved by the designated application once it is restarted. This way, the disclosed methods and devices improve the timeliness and accuracy for acquiring the data required by the designated application when it enters the foreground state.

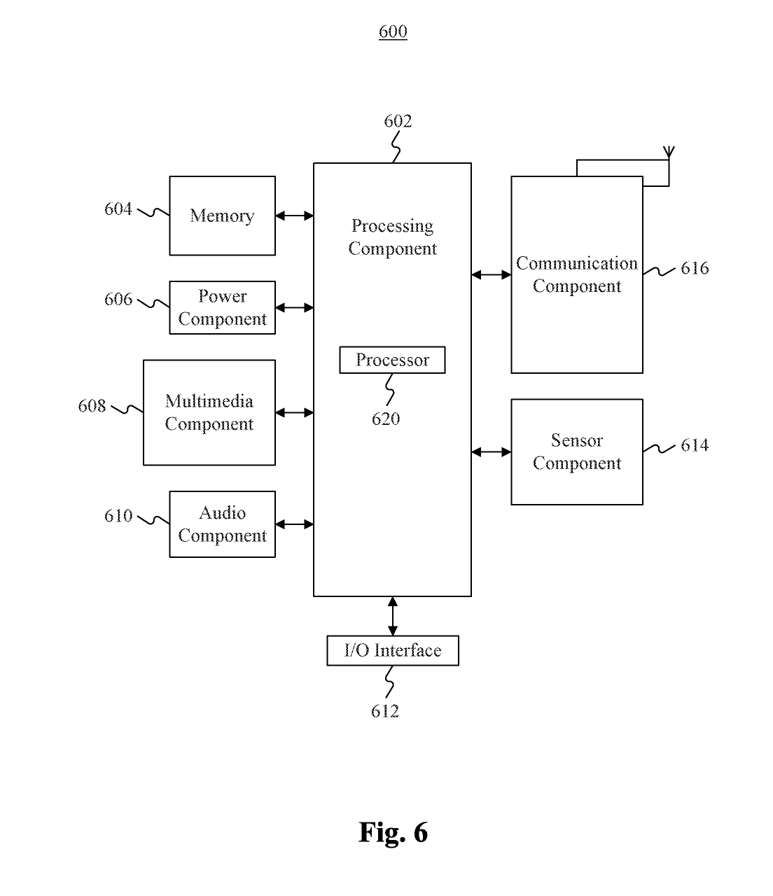

FIG. 6 is a block diagram of a terminal 600, according to an exemplary embodiment. For example, the terminal 600 may be a mobile phone, a computer, a digital broadcast terminal, a messaging device, a gaming console, a tablet, a medical device, exercise equipment, a personal digital assistant, and the like. In some embodiments, the above-described device 400 is implemented as a part or the whole of the terminal 600.

Referring to FIG. 6, the terminal 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the terminal 600, such as the operations associated with display, telephone calls, data communications, camera operations, and recording operations. The processing component 602 may include one or more processors 620 to execute instructions to perform all or some of the steps in the above-described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the terminal 600. Examples of such data include instructions for any applications or methods operated on the terminal 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the terminal 600. The power component 606 may include a power management system, one or more power sources, and any other components associated with the generation, management, and distribution of power for the terminal 600.

The multimedia component 608 includes a screen providing an output interface between the terminal 600 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the terminal 600 is in an operation mode, such as a photographing mode or a video mode. Each of the front camera and the rear camera may be a fixed optical lens system or have optical focusing and zooming capability.

The audio component 610 is configured to output and/or input audio signals. For example, the audio component 610 includes a microphone configured to receive an external audio signal when the terminal 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, the peripheral interface modules being, for example, a keyboard, a click wheel, buttons, and the like. The buttons may include, but are not limited to, a home button, a volume button, a starting button, and a locking button.

The sensor component 614 includes one or more sensors to provide status assessments of various aspects of the terminal 600. For instance, the sensor component 614 may detect an open/closed status of the terminal 600, relative positioning of components (e.g., the display and the keypad, of the terminal 600), a change in position of the terminal 600 or a component of the terminal 600, a presence or absence of user contact with the terminal 600, an orientation or an acceleration/deceleration of the terminal 600, and a change in temperature of the terminal 600. The sensor component 614 may include a proximity sensor configured to detect the presence of a nearby object without any physical contact. The sensor component 614 may also include a light sensor, such as a complementary metal oxide semiconductor (CMOS) or a charge coupled device (CCD) image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the terminal 600 and other devices. The terminal 600 can access a wireless network based on a communication standard, such as WiFi, 2G, 3G, 4G, or a combination thereof. In an exemplary embodiment, the communication component 616 receives a broadcast signal or broadcast associated information from an external broadcast management system via a broadcast channel In an exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 604, executable by the processor 620 in the terminal 600, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for calling a process, comprising:
setting a call frequency for a process to be called by a designated application, based on a usage state of the designated application; and
calling the process at the set call frequency.

2. The method of claim 1, wherein the setting of the call frequency for the process to be called by the designated application further includes:
monitoring the usage state of the designated application;
when the usage state of the designated application changes, determining a call frequency corresponding to the changed usage state of the designated application; and
setting the call frequency for the process to be called by the designated application, based on the call frequency corresponding to the changed usage state of the designated application.

3. The method of claim 1, wherein the usage state includes at least one of a foreground state, a background state, or a closed state.

4. The method of claim 2, wherein the usage state includes at least one of a foreground state, a background state, or a closed state.

5. The method of claim 3, wherein:
a call frequency corresponding to the foreground state is higher than a call frequency corresponding to the background state; and
the call frequency corresponding to the background state is higher than a call frequency corresponding to the closed state.

6. The method of claim 4, wherein:
a call frequency corresponding to the foreground state is higher than a call frequency corresponding to the background state; and
the call frequency corresponding to the background state is higher than a call frequency corresponding to the closed state.

7. The method of claim 4, further comprising:
when the designated application is in the closed state, storing data generated by the process called by the designated application; and
when the designated application changes from the closed state to the foreground state, retrieving the stored data.

8. A device for calling a process, comprising:
a processor; and
a memory for storing instructions executable by the processor;
wherein the processor is configured to:
set a call frequency for a process to be called by a designated application, based on a usage state of the designated application; and
call the process at the set call frequency.

9. The device of claim 8, wherein the processor is further configured to:
monitor the usage state of the designated application;
when the usage state of the designated application changes, determine a call frequency corresponding to the changed usage state of the designated application; and
set the call frequency for the process to be called by the designated application based on the call frequency corresponding to the changed usage state of the designated application.

10. The device of claims 8, wherein the usage state includes at least one of a foreground state, a background state, or a closed state.

11. The device of claims 9, wherein the usage state includes at least one of a foreground state, a background state, or a closed state.

12. The device of claim 10, wherein:
a call frequency corresponding to the foreground state is higher than a call frequency corresponding to the background state; and
the call frequency corresponding to the background state is higher than a call frequency corresponding to the closed state.

13. The device of claim 11, wherein:
a call frequency corresponding to the foreground state is higher than a call frequency corresponding to the background state; and
the call frequency corresponding to the background state is higher than a call frequency corresponding to the closed state.

14. The device of claim 11, wherein the processor is further configured to:
when the designated application is in the closed state, store data generated by the process called by the designated application; and
when the designated application changes from the closed state to the foreground state, retrieve the stored data.

15. A non-transitory computer-readable storage medium storing instructions that, when executed by a processor of a terminal, cause the terminal to perform a method for calling a process, the method comprising:
setting a call frequency for a process to be called by a designated application, based on a usage state of the designated application; and
calling the process at the set call frequency.
